(19) United States
(12) Patent Application Publication
(10) Pub. No.: US 2025/0292075 A1
(43) Pub. Date: Sep. 18, 2025

(54) NON-LINEAR CURRENT ATTENUATION IN NEURAL NETWORKS

(71) Applicant: STMicroelectronics International N.V., Geneva (CH)

(72) Inventors: Joao Henrique QUINTINO PALHARES, Grenoble (FR); Philippe GALY, Le Touvet (FR)

(73) Assignee: STMicroelectronics International N.V., Geneva (CH)

(21) Appl. No.: 19/076,596

(22) Filed: Mar. 11, 2025

(30) Foreign Application Priority Data
Mar. 15, 2024 (FR) FR2402603

(51) Int. Cl. G06N 3/063

(52) U.S. Cl. CPC G06N 3/063

(57) ABSTRACT

A neural network circuit having at least one first neuron coupled to a second neuron via at least one synapse. A non-linear current attenuator receives a first current from the at least one synapse and provides a second current to the second neuron.

### PRIORITY CLAIM

This application claims the priority benefit of French Application for Pat. No. 2402603, filed on Mar. 15, 2024, the content of which is hereby incorporated by reference in its entirety to the maximum extent allowable by law.

### TECHNICAL FIELD

The present disclosure relates generally to electronic devices and systems and to their implementation. The present disclosure concerns more particularly to neural networks and to their implementations.

### BACKGROUND

Neural networks, and more particularly artificial neural networks, are a type of artificial intelligence and machine learning models based on the principles of neuronal organization found in the biological neural networks constituting animal brains.

It would be desirable to be able to improve at least in part certain aspects of the implementation of neural networks.

There is a need for more efficient neural networks.

There is a need for neural networks using current attenuation between layers of neurons.

There is a need for neural networks using current attenuation between a synapse and a spiking neuron.

There is a need for more efficient neural networks comprising synapse using multilevel phase change memory cells.

There is a need for neural networks capable of compensating a resistance drift and a dispersion of memory cells used for forming a synapse.

There is a need for neural networks capable of compensating a resistance drift and a dispersion of phase change memory cells used for forming a synapse.

### SUMMARY

Embodiments herein address all or some of the drawbacks of known neural networks.

One embodiment provides a neural network circuit using a non-linear current attenuator between two layers of neurons.

One embodiment provides a neural network circuit using a non-linear current attenuator between a synapse and a spiking neuron.

One embodiment provides a neural network circuit comprising at least one first neuron coupled to a second neuron via at least one synapse, and a non-linear current attenuator configured to receive a first current from said at least one synapse and to provide a second current to said second neuron.

According to an embodiment, said at least one synapse comprises a multi-level memory cell.

According to an embodiment, said at least one synapse comprises a multi-level phase change memory cell.

According to an embodiment, said first current is a reading current of said at least one first neuron.

According to an embodiment, the neural network circuit comprises at least two first neurons and at least two synapses, said first current is the sum of third currents provided by each of said at least two synapses.

According to an embodiment, said at least one first neuron is a spiking neuron.

According to an embodiment, said second neuron is a spiking neuron.

According to an embodiment, said non-linear current attenuator is non-linear in regards of said first current.

According to an embodiment, said second current depends of the first current via an exponential function.

According to an embodiment, said second current is given by the following mathematical formula:

$$Iout 300 = \frac{Iin 300}{SDFmax - SDFmin * {e}^{- λ * Iin 300}} \qquad ( Eq . 1 )$$

Wherein: Iin300 represents said first current; SDFmax represents the maximum gain provided by said attenuator; SDFmin represents the minimum gain provided by said attenuator; and A is a coefficient defined in an experimental fashion.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates the principle of two layers of a neural network that are fully connected;

FIG. 2 illustrates an embodiment of a part of a neural network;

FIG. 3 illustrates a detailed embodiment of a part of a neural network;

FIG. 4 illustrates a graph illustrating the embodiment of FIG. 3; and

FIG. 5 illustrates other graphs illustrating the embodiment of FIG. 3.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

The above described embodiments concern implementations of neural networks, and more particularly implementations of spiking neural networks. A neural network is a machine learning model based on the principles of neuronal organization found in the biological neural network constituting animal brains. Nowadays neural networks are implemented by electronic devices and circuits. A neural networks comprises several layers of neurons, each neuron being coupled to neurons of other layers by connections called synapses that constitute the weighted memory.

In electronic implementation of neural networks, each neuron is a transfer function cell transferring voltages and current to other neurons via a synapse that is, in practical, one or several memory cells, preferably one memory cell. The use of current attenuator between a synapse and a neuron is essential for a good operation of neural networks. In certain case, multi-level memory cells are used to formed part of a synapse, such as multi-level phase change memory cells. These memory cells can face, overtime, resistance drift and dispersion phenomenon that can lead to implementation issues. The above-described embodiments propose to use non-linear current attenuator between a synapse and a neuron to compensate these resistance deviations.

Moreover, the above-described embodiments are particularly adapted to be included into chip configured to implement artificial intelligence functions.

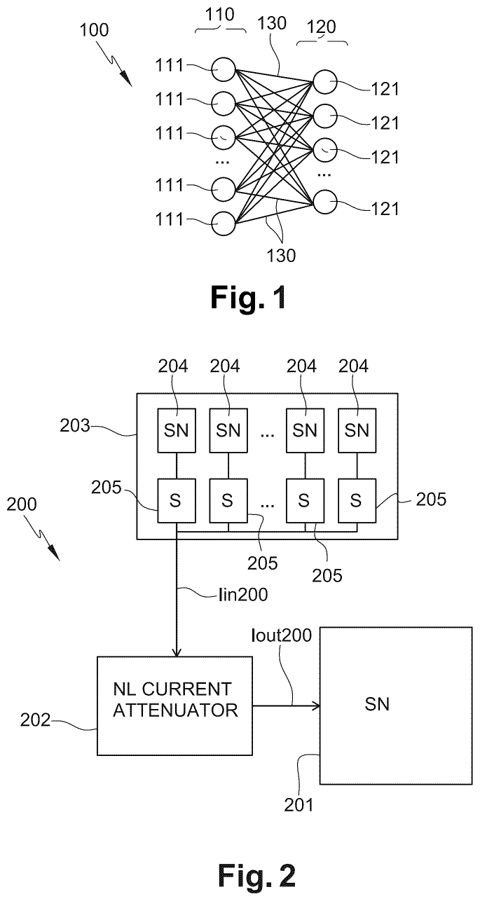

FIG. 1 illustrates, very schematically, a neural network 100 comprising two layers of neurons fully connected to each other.

Neural network 100 comprises two layers 110 and 120 of neurons, wherein neurons are coupled by synapses 130. More particularly, layer 110 comprises several neurons 111, and layer 120 comprises several neurons 121. Each neuron 111 is coupled to each neuron 121 of layer 120 via one synapse 130, and, in consequence, each neuron 121 is coupled to each neuron 111 of layer 110 via one synapse 130.

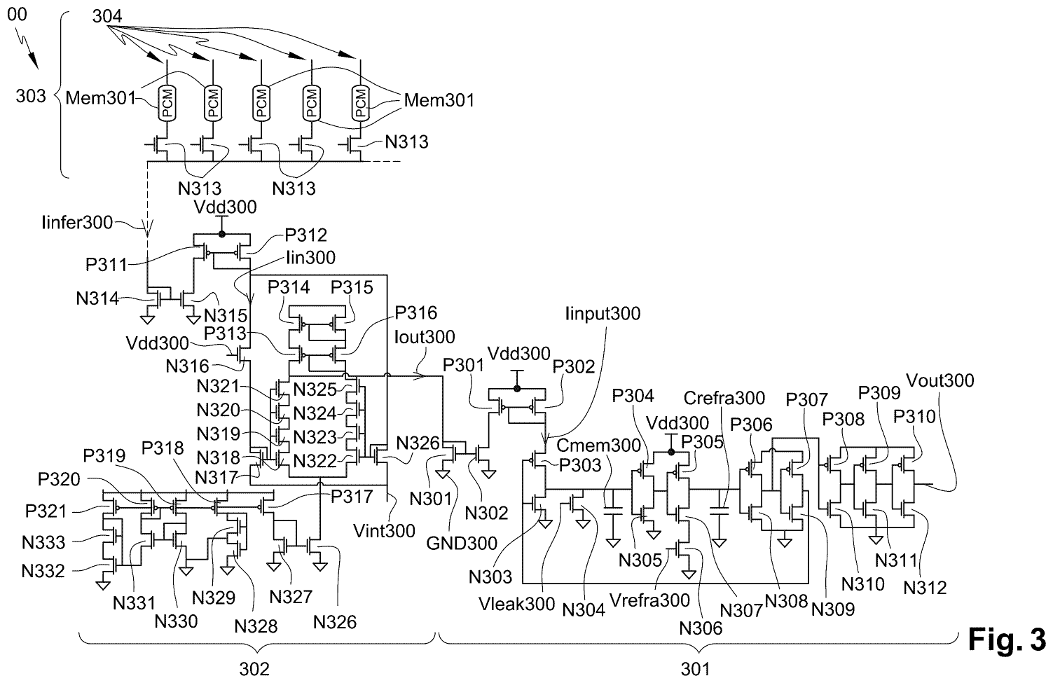

Several kinds of neurons exist. Neurons 111 and 121 can be spiking neurons. Spiking neurons are artificial neurons that more closely mimic natural neural networks. They are adapted to receive analog data, and to provide a spiking data, meaning data of spike form. A detailed example of a spiking neuron is described in relation with FIG. 3.

A part of synapse 130 can be implemented by using memory cells. More particularly, a part of synapse 130 can be implemented by a multi-level memory cell, meaning a memory capable of storing more than two different values of a data. According to an embodiment, synapse 130 can be implemented by using a phase change memory (PCM) cell, and more particularly a multi-level phase change memory cell.

A phase change memory cell uses a phase transition of a material to store a binary data. When the material is in a first phase the value of the data is a first value, for example a logic one (1), and when the material is in a second phase the value of the data is a second value different from the first value, for example a logic zero (0). A reading operation is based on the resistance value of said material.

A multi-level phase change memory cell uses a material capable of modifying its resistance value into more than two distinguishable values. More particularly, such a memory cell can be capable of storing eight (8) distinguishable values. However, a common issue with multi-level phase change memory cell is a resistance drift and dispersion, meaning the value of resistance of its material drift over time. The embodiment disclosed hereafter proposes to compensate this drift.

FIG. 2 represents, very schematically and in block form, an embodiment of a part 200 of a neural network. Part 200 focuses on inputs of a neuron.

Part 200 comprises a neuron 201. According to an embodiment, neuron 201 is a spiking neuron (SN). Neuron 201 is capable of receiving a current Iout200 from another layer of neurons of the neural network. As said previously, a detailed example of a spiking neuron is described in relation with FIG. 3.

Part 200 further comprises a non-linear current attenuator 202 (NL CURRENT ATTENUATOR) configured to provide current Iout200 to said neuron 201. Attenuator 202 is capable of receiving a current Iin200 and to apply a non-linear function to said current Iin200 in order to provide current Iout200. In other words, current Iout200 is non-linear regarding current Iin200. A detailed example of such an attenuator is described in relation with FIG. 3.

Part 200 further comprises a layer 203 of neurons 204 (SN) and the associated synapse 205 (S) of the neural networks. According to an example, each neuron 204 is coupled to neuron 201 via a synapse 205. More particularly, each neuron 204 is coupled to the current attenuator 202 via a synapse 205. According to an embodiment, such as neuron 201, each neuron 204 is a spiking neuron.

According to an embodiment, each synapse 205 is modeled by a memory cell, and more particularly by a multi-level memory cell. According to a preferred example, a part of each synapse 205 can be modeled by a phase change memory cell, and more particularly by a multi-level phase change memory cell. Each synapse 205 is coupled to neuron 201 via the non-linear current attenuator 202. More particularly, all outputs of synapses 205 are coupled to an input node of attenuator 202. Thus, current Iin200 is the sum of each output current of synapses 205. Moreover, each output current of synapses 205 is a result of voltage pulses converted into current by resistive elements of synapses 205, and more particularly by the memory cells of synapses 205. The inventors discovered that using a non-linear current attenuator between synapses 205 and neuron 201 compensates a resistance drift and dispersion phenomenon occurring in synapses 205.

FIG. 3 is a circuit diagram of a part 300 of a neural network of type of part 200 described in relation with FIG. 2.

Such as part 200 of FIG. 2, part 300 focuses on inputs of a neuron 301. Part 300 comprises: a neuron 301; a non-linear current attenuator 302; and a layer 303 of synapses 304 coupled to neuron 301.

According to an embodiment, neuron 301 is a post synaptic analog neuron, and, for example, a spiking neuron. Neuron 301 is configured to receive a current Iout300, and to provide an output voltage Vout300.

According to an example, neuron 301 is constituted of metal-oxide-semiconductor field-effect transistors, or MOSFET transistors, or MOS transistors. More particularly, neuron 301 is constituted of N-channel MOS transistors, or N-type MOS transistors, or NMOS transistors, and P-channel MOS transistors, or P-type MOS transistors, or PMOS transistors.

According to one example, neuron 301 comprises a first current mirror circuit containing two NMOS transistors N301 and N302. A drain terminal of transistor N301 is coupled, preferably connected, to a node providing current Iout300, and is also coupled to gate terminals of transistors N301 and N302. Source terminals of transistors N301 and N302 are both coupled, preferably connected, to a node providing a reference voltage GND300, such as the ground.

According to an example, neuron 301 comprises a second current mirror circuit containing two PMOS transistors P301 and P302. A drain terminal of transistor P301 is coupled, preferably connected, to a source terminal of transistor N302. Source terminals of transistors P301 and P302 are both coupled, preferably connected, to a node providing a supply voltage Vdd300. A drain terminal of transistor P302 is coupled, preferably connected, to gate terminals of transistors P301 and P302, and provides a current Iinput300 that is an image of current Iout300.

According to an example, neuron 301 comprises a PMOS transistor P303 and an NMOS transistor N303. A source terminal of transistor P303 is coupled, preferably connected, to the drain terminal of transistor P302, and, thus, receives current Iinput300. Drain terminals of transistors P303 and N303 are coupled, preferably connected, to each other. Source terminal of transistor N303 receives reference voltage GND300.

According to an example, neuron 301 comprises an NMOS transistor N304 and a capacitor Cmem300. A drain terminal of transistor N304 is coupled, preferably connected, to the drain terminals of transistors N303 and P303, and a source terminal of transistor N304 receives the reference voltage GND300. Gate terminal of transistor N304 receives a control voltage Vleak300. Capacitor Cmem300 is coupled between the drain terminals of transistors N303 and P303 and the node providing reference voltage GND300. Transistor N304 is used as the neuron 301 leaking element. Capacitor Cmem300 is a storing capacitor, also known a membrane capacitor.

According to an example, neuron 301 comprises two (2) PMOS transistors P304 and P305 and three (3) NMOS transistors N305, N306 and N307. A source terminal of transistor P304 receives supply voltage Vdd300. Drain terminals of transistors P304 and N305 are coupled, preferably connected, to each other. Source terminal of transistor N305 receives reference voltage GND300. Gate terminals of transistors P304 and N305 are coupled, preferably connected, to the drain terminals of transistors P303 and N303. A source terminal of transistor P305 receives supply voltage Vdd300. Drain terminals of transistors P305 and N306 are coupled, preferably connected, to each other. Source terminal of transistor N306 is coupled, preferably connected to the drain terminal of transistor N307. Gate terminals of transistors P305 and N306 are coupled, preferably connected, to the drain terminals of transistors P304 and N305. Source terminal of transistor N307 is coupled, preferably connected, to reference voltage GND300. Gate terminal of transistor N307 receives a control voltage Vrefra300. Control voltage Vrefra300 is used to control the refractory period of neuron 301, which is the duration when neuron 301 becomes unresponsive to any input current Iinput300.

According to an example, neuron 301 comprises a capacitor Crefra300 coupled, preferably connected, between the drain terminals of transistors P305 and N306.

According to an example, neuron 301 comprises two (2) PMOS transistors P306 and P307 and two (2) NMOS transistors N308 and N309. Source terminals of transistors P306 and P307 are coupled, preferably connected, to each other. Drain terminals of transistors P306 and N308 are coupled, preferably connected, to each other. Source terminal of transistor N308 receives reference voltage GND300. Gate terminals of transistors P306 and N308 are coupled, preferably connected, to the drain terminals of transistors P305 and N306. Drain terminals of transistors P307 and N309 are coupled, preferably connected, to each other. Source terminal of transistor N309 receives the reference voltage GND300. Gate terminals of transistors P307 and N309 are coupled, preferably connected, to the drain terminals of transistors P306 and N308.

According to an example, neuron 301 comprises three (3) PMOS transistors P308, P309 and P310 and three (3) NMOS transistors N310, N311 and N312. Source terminals of transistors P308, P309 and P310 are coupled, preferably connected, to each other. Drain terminals of transistors P308 and N310 are coupled, preferably connected, to each other. Source terminal of transistor N310 receives reference voltage GND300. Gate terminals of transistor P308 and N310 are coupled, preferably connected, to the drain terminals of transistors P306 and N308. Drain terminals of transistors P309 and N311 are coupled, preferably connected, to each other. Source terminal of transistor N311 receives the reference voltage GND300. Gate terminals of transistor P309 and N311 are coupled, preferably connected, to the drain terminals of transistors P308 and N310. Drain terminals of transistors P310 and N312 are coupled, preferably connected, to each other. Source terminal of transistor N312 receives the reference voltage GND300. Gate terminals of transistor P310 and N312 are coupled, preferably connected, to each other and provide the output voltage Vout300 of neurons 301.

According to an embodiment, layer 303 comprises several synapses 304 placed in an array or a column. Only a part of each synapse 304 is represented in FIG. 3, this part comprises a memory cell Mem301 (PCM) and a selection NMOS transistor N313, or selector N313. According to an embodiment, memory cell Mem301 is a multi-level memory cell. According to an embodiment, memory cell Mem301 is a phase change memory cell, and, for example, a multi-level phase change memory cell. As said earlier, memory cell Mem301 faces a resistance drift phenomenon. A first conduction terminal of transistor N313 is coupled, preferably connected, to the output of memory cell Mem301, and a second conduction terminal of transistor N313 provides a reading current of synapses 304, also called inference current of synapses 304. Gate terminal of transistor N313 receives a selection voltage.

All the synapses 304 of layer 303 have their output coupled, preferably connected, to each other. This means that all second conduction terminal of transistors N313 are coupled, preferably connected, to each other. Layer 303 provides a current Iinfer300 to the current attenuator 302. Current Iinfer300 is the sum of all the reading current of synapses 304.

According to an embodiment, non-linear current attenuator 302 comprises a first current mirror circuit containing two NMOS transistors N314 and N315. A drain terminal of transistor N314 is coupled, preferably connected, to a node providing current Iinfer300, and is also coupled to gate terminals of transistors N314 and N315. Source terminals of transistors N314 and N315 are both coupled, preferably connected, to a node providing a reference voltage GND300, such as the ground.

According to an example, attenuator 302 comprises a second current mirror circuit containing two PMOS transistors P311 and P312. A drain terminal of transistor P311 is coupled, preferably connected, to a source terminal of transistor N315. Source terminals of transistors P311 and P312 are both coupled, preferably connected, to a node providing a supply voltage Vdd300. A drain terminal of transistor P312 is coupled, preferably connected, to gate terminals of transistors P311 and P312, and provides a current Iin300 that is an image of current Iinfer300, which is also called input current Iin300.

According to an example, attenuator 302 comprises two NMOS transistor N316 and N317. A first conduction terminal of transistor N316 is coupled, preferably connected, to the drain terminal of transistor P312. A second conduction terminal of transistor N316 is coupled, preferably connected, to a source terminal of transistor N317. Gate terminal of transistor N317 receives the supply voltage Vdd300. Drain terminal of transistor N317 provides an intermediate voltage Vint300.

According to an example, attenuator 302 comprises eight (8) NMOS transistors N318, N319, N320, N321, N322, N323, N324, and N325, and four (4) PMOS transistors P313, P314, P315 and P316.

Gate terminals of transistors N318, N319, N320 and N321 are all coupled, preferably connected, to each other, to the gate terminal of transistor N317 and to the source terminal of transistor N317. Transistors N318, N319, N320 and N321 are all coupled, preferably connected, in series. In other words, a first conduction terminal of transistor N318 is coupled, preferably connected, to a first conduction terminal of transistor N319. A second conduction terminal of transistor N319 is coupled, preferably connected, to a first conduction terminal of transistor N320. A second conduction terminal of transistor N320 is coupled, preferably connected, to a first conduction terminal of transistor N321.

Gate terminals of transistors N322, N323, N324 and N325 are all coupled, preferably connected, to each other. Transistors N322, N323, N324 and N325 are all coupled, preferably connected, in series. In other words, a first conduction terminal of transistor N322 is coupled, preferably connected, to a first conduction terminal of transistor N323. A second conduction terminal of transistor N323 is coupled, preferably connected, to a first conduction terminal of transistor N324. A second conduction terminal of transistor N324 is coupled, preferably connected, to a first conduction terminal of transistor N325.

First conduction terminal of transistor P313 is coupled, preferably connected, to a second conduction terminal of transistor N321. Second conduction terminal of transistor P313 is coupled, preferably connected, to a first conduction terminal of transistor P314. First conduction terminal of transistor P315 is coupled, preferably connected, to a second conduction terminal of transistor N325. Second conduction terminal of transistor P315 is coupled, preferably connected, to a first conduction terminal of transistor P316. Gate terminals of transistors P313 and P315 are coupled, preferably connected, to each other, and to the first conduction terminal of transistor P315. Gate terminals of transistors P314 and P316 are coupled, preferably connected, to each other, and to the first conduction terminal of transistor P316.

According to an example, attenuator 302 comprises an NMOS transistors N326. A first conduction terminal of transistor N326 is coupled, preferably connected, to the drain terminal of transistor P312. A second conduction terminal of transistor N326 is coupled, preferably connected, to the drain terminal of N317, and also provides intermediate voltage Vint300.

According to an example, attenuator 302 comprises two NMOS transistors N326′ and N327, and a PMOS transistor P317. A drain terminal of transistor N326′ is coupled, preferably connected, to the second conduction terminals of transistors N318 and N322. A source terminal of transistor N326′ receives the reference voltage GND300. Gate terminals of transistors N327 and N328 are coupled, preferably connected, to each other, to the drain terminal of transistor N327 and to the source terminal of transistor P317. Source terminal of transistor N327 is receives the reference voltage GND300.

According to an example, attenuator 302 comprises two (2) NMOS transistors N328 and N329, and a PMOS transistor P318. A source terminal of transistor P318 is coupled, preferably connected, to the source terminal of transistor P317. A gate terminal of transistor P318 is coupled, preferably connected, to the gate terminal of transistor P317. A drain terminal of transistor P318 is coupled, preferably connected, to the drain terminal of transistor N329. A source terminal of transistor N329 is coupled, preferably connected, to the drain terminal of transistor N328. A source terminal of transistor N329 receives the reference voltage GND300. Gate terminals of transistors N328 and N329 are coupled, preferably connected, to each other and to the drain terminal of transistor N328.

According to an example, attenuator 302 comprises two (2) NMOS transistors N330 and N331, and two (2) PMOS transistors P319 and P320. A source terminal of transistor P319 is coupled, preferably connected, to the source terminal of transistor P317. A gate terminal of transistor P319 is coupled, preferably connected, to the gate terminal of transistor P317. A source terminal of transistor P320 is coupled, preferably connected, to the source terminal of transistor P317. A gate terminal of transistor P320 is coupled, preferably connected, to the gate terminal of transistor P317. A drain terminal of transistor N330 is coupled, preferably connected, to the drain terminal of transistor P319. A source terminal of transistor N330 receives the reference voltage GND300. Gate terminals of transistors N330 and N331 are coupled, preferably connected, to each other, to the drain terminal of transistor N330 and to the source terminal of transistor P318.

According to an example, attenuator 302 comprises two (2) NMOS transistors N332 and N333, and a PMOS transistor P321. A source terminal of transistor P321 is coupled, preferably connected, to the source terminal of transistor P317. A gate terminal of transistor P321 is coupled, preferably connected, to the gate terminal of transistor P317. A drain terminal of transistor P321 is coupled, preferably connected, to the drain terminal of transistor N333 and to the gate terminal of transistor N333. A source terminal of transistor N333 is coupled, preferably connected, to the drain terminal of transistor N332. A source terminal of transistor N333 receives the reference voltage GND300. Gate terminals of transistors N332 and N333 are coupled, preferably connected, to each other and to the source terminal of transistor N331.

A self-biasing current reference circuit of attenuator 302 comprises transistors N326 to N333 and P317 to P321, and generates a sub-threshold current that is conveyed by the current mirror N327 to N326 responsible to limit the Iout300 of the current attenuator. The current bias conveyed by N326 is the biasing current.

As said previously, attenuator 302 is a non-linear current attenuator configured to provide an output current Iout300 of which evolution is not Iinear regarding the evolution of the input current Iin300. In the example illustrated in FIG. 3, output current Iout300 depends on the input current Iin300 via an one-phase-exponential decay function. More particularly, output current Iout300 is given by the following mathematical formula:

$$Iout 300 = \frac{I i n 300}{SDFmax - SDFmin * {e}^{- λ * Iin 300}} \qquad ( Eq . 2 )$$

wherein: SDFmax represents the maximum gain provided by attenuator 302, meaning the maximum current scale down factor (SDF); SDFmin represents the minimum gain provided by attenuator 302, meaning the minimum current scale down factor (SDF); and λ is a coefficient defined in an experimental fashion.

Furthermore, the scale down factor function SDF of attenuator 302 is given by the following mathematical formula:

$$SDF ( Iin 300 ) = SDFmax - {SDFmine}^{- λ * Iin 300} \qquad ( Eq . 3 )$$

The current scale down factor (SDF) or the gain of the attenuator, defined as the ratio between current Iin300 and current Iout300, is not Iinear with respect to Iin300 for some examples of operation conditions or some example of operation modes. It is not Iinear because the output current Iout300 is initially constant regardless of the increase of Iin300. This mode is triggered whenever voltage Vint300 is sufficient to saturate transistor N326 even during the operation start, meaning when current Iin300 is equal to zero. Transistors N316 to N317 are connected to transistor N326 as source followers. Thus, a change in the voltage Vint300 will not only cause a change in the gate voltage of transistors N317 and N316 but will also change the drain voltage of N326. Transistor N326 will be in saturation whenever the drain voltage is greater than approximately four times the thermal potential. The common mode rejection rate (CMRR) of attenuator 302 is high when the biasing current conveyed by transistor N326 is constant, meaning that transistor N326 is in saturation, so the output current Iout300 just depends on the differential input change of the gate terminals of transistors N316 and N317, that depends on current Iin300. As current Iin300 increases the differential input change increases. Finally, current Iout300 is initially constant since during operation start current Iin300, meaning the differential input change, is not sufficient to drive/change the Iout300.

On the contrary, when Vint300 is not sufficient to saturate transistor N326 and its biasing current is not constant, meaning that it is rather at triode region with high transconductance, so that the common mode rejection rate is reduced and current Iout300 depends on the common mode voltage of transistor N326. Thus, any increase in Vint300 will generate an increase in Iout300, and so Iout300 is not initially constant or saturated. Thus, Iout300 is not constant and increases as Iin300 increases even for small values of the latter, meaning that current scale down factor (SDF) of the attenuator 302 is Iinear for this example of operation mode.

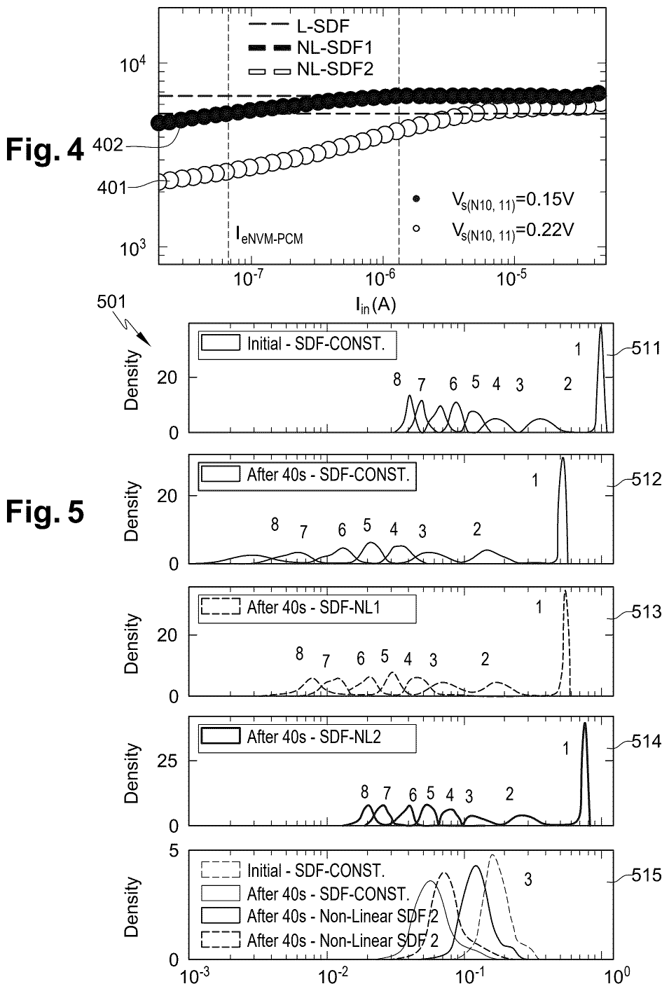

FIG. 4 is a graph representing the gain or the current scale down factor (SDF) of the attenuator 302 described in relation with FIG. 3 regarding the input current In300 (Iin (A)).

The gain of the attenuator 302 is defined by the division of the input current In300 by the output current Iout300.

Graph of FIG. 4 depicts a series 401 of points illustrating a first configuration of attenuator 302, and a series 402 of points illustrating a second configuration of attenuator 302. The two configurations of attenuator 302 share the same non-linear configuration mode, just with a different degree of tunability. The non-linear operation is attained whenever a voltage Vbias300 is enough to saturate transistor N326 from the very start of the operation of the attenuator (for small values of Iin300). The common mode rejection rate of the attenuator 302 is high enough to make current Iout300 constant and not change whenever the common mode voltage of the gate voltage of transistors N317 and N316, that increases with Iin300, are not sufficiently high. So, for small values of Iin300, Iin300 increases while Iout300 is constant, which makes the gain/current scale down factor non-linear—this condition is depicted by curves 401 and 402 for a Vbias300 equal to 0.1 V and for a Vbias300 equal to 0.2 V. To tune it we change Vbias300. As we increase Vbias300 we increase the drain voltage of transistor N326 and makes it saturate earlier whenever voltage Vbias300 is equal to 0.22 V (curve 401) compared 0.15V (curve 402).

Graph of FIG. 4 shows directly that attenuator 302 is non-linear.

FIG. 5 comprises a series of graphs 501 illustrating the result of using attenuator 302 described in relation with FIG. 3.

Series of graphs 501 comprises:
a graph 511 illustrating the normalization of reading currents of synapses 304 described in relation with FIG. 3, after the use of a Iinear current attenuator at an initial time;
a graph 512 illustrating the normalization of reading currents of synapses 304 after the use of a Iinear current attenuator at another time consecutive to the initial time;
a graph 513 illustrating the normalization of reading currents of synapses 304 after the use of the non-linear current attenuator 302, with the first configuration, at said other time consecutive to the initial time;
a graph 514 illustrating the normalization of reading currents of synapses 304 after the use of the non-linear current attenuator 302, with the second configuration, at said other time consecutive to the initial time; and
a graph 515 illustrating the comparison of the resistance drift phenomenon between the case illustrated by graph 511 to 514.

The difference between graphs 511 and 512 shows the resistance drift phenomenon described previously. Graphs 513 to 515 shows the impact of the use of a non-linear current attenuator, and more especially the impact of the use of the non-linear current attenuator 302 of FIG. 3. A non-linear current attenuator has the effect of reducing the resistance drift phenomenon.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A neural network circuit, comprising:
at least one first neuron;
a second neuron;
at least one synapse coupled to an output of the at least one first neuron and configured to generate a first current; and
a non-linear current attenuator configured to receive the first current from said at least one synapse and to provide a second current to an input of said second neuron.

2. The neural network circuit according to claim 1, wherein said at least one synapse comprises a multi-level memory cell.

3. The neural network circuit according to claim 1, wherein said at least one synapse comprises a multi-level phase change memory cell.

4. The neural network circuit according to claim 1, wherein said first current is a reading current which is output from said at least one first neuron.

5. The neural network circuit according to claim 1, wherein said at least one first neuron comprises at least two first neurons and at least two synapses, wherein said first current is a sum of third currents output from each of said at least two synapses.

6. The neural network circuit according to claim 1, wherein said at least one first neuron is a spiking neuron.

7. The neural network circuit according to claim 1, wherein said second neuron is a spiking neuron.

8. The neural network circuit according to claim 1, wherein said non-linear current attenuator is non-linear in regards of said first current.

9. The neural network circuit according to claim 8, wherein said second current depends on the first current via an exponential function.

10. The neural network circuit according to claim 9, wherein said second current (Iout300) is given by the following mathematical formula:
$$Iout 300 = \frac{Iin 300}{SDFmax - SDFmin * {e}^{- λ * Iin 300}}$$
wherein: Iin300 is said first current; SDFmax is a maximum gain provided by said non-linear current attenuator; SDFmin is a minimum gain provided by said non-linear current attenuator; and λ is a coefficient defined in an experimental fashion.
